(19) United States
(12) Patent Application Publication
(10) Pub. No.: US 2015/0371277 A1
(43) Pub. Date: Dec. 24, 2015

(54) INFERRING AN INDUSTRY ASSOCIATED WITH A COMPANY BASED ON JOB TITLES OF COMPANY EMPLOYEES

(71) Applicant: Facebook, Inc., Menlo Park, CA (US)

(72) Inventors: Ismail Onur Filiz, El Cerrito, CA (US); Amac Herdagdelen, Mountain View, CA (US); Jonathan Chang, San Francisco, CA (US)

(21) Appl. No.: 14/309,038

(22) Filed: Jun. 19, 2014

(51) Int. Cl. G06Q 30/02; G06Q 50/00

(52) U.S. Cl. CPC G06Q 30/0269; G06Q 50/01

(57) ABSTRACT

A social networking system infers an industry associated with a company identified as an employer of a social networking system user. Job titles associated with employees of companies are identified and a value is associated with various companies based on the distributions of job titles of each company's employees. For various industries, an industry value is determined based on the values determined for companies associated with an industry. A company that is not associated with an industry is identified and a value is determined for the company based on a distribution of job titles of the identified company's employees. The social networking system applies a model to the value for the identified company to determine an industry value associated with the identified company, and an industry associated with the determined industry value is associated with the identified company.

### BACKGROUND

This disclosure relates generally to social networking systems, and in particular to inferring industries associated with companies associated with social networking system users.

A social networking system allows users to connect to and to communicate with other users of the social networking system. Users create profiles on a social networking system that are tied to their identities and include information about the users, such as interests and demographic information. The users may be individuals or entities such as corporations or charities. Because of the increasing popularity of social networking systems and the significant amount of user-specific information maintained by social networking systems, a social networking system provides an ideal forum for advertisers to increase awareness about products or services by presenting advertisements to social networking system users.

Presenting advertisements to social networking system users allows an advertiser to gain public attention for products or services or to persuade social networking system users to take an action regarding the advertiser's products or services. Many social networking systems generate revenue by displaying advertisements to their users. Frequently, social networking systems charge advertisers for each presentation of an advertisement to a social networking system user (e.g., each “impression” of the advertisement) or interaction with an advertisement by a social networking system user.

A cconventional social networking system provides a user with an option to provide and maintain information describing employment information in a user profile maintained by the social networking system. For example, a user specifies a job title, identifies a company as an employer, identifies one or more professional skills, or other suitable information in a user profile maintained by the social networking system. In addition to maintaining more complete information describing a user, the social networking system may also use employment information specified by a user as targeting criteria for selecting content for presentation to the user. For example, an advertiser for a work uniform company may use employment information specified by a user profile to select advertisements for certain types of products or services for presentation to a user associated with the user profile. As another example, a user specifying an employer providing health care services may be identified as eligible to receive advertisements for medical equipment. Additionally, employment information may allow a social networking system user to identify additional social networking system users working in a particular industry or having a particular job title. However, social networking systems do not require users to specify employment information in user profiles, which may impair user interaction with other social networking system users and selection of content for presentation to different social networking system users.

### SUMMARY

To improve selection of content for various users and interaction between users, a social networking system infers an industry associated with a company based on industries associated with additional companies. Names, sizes, and distributions of job titles specified by social networking system users are retrieved by the social networking system for various companies specifying an association with an industry. For example, the social networking system retrieves information about a distribution of job titles in a company with an association to the airline industry. In some embodiments, the social networking system retrieves information describing distributions of job titles, names, and sizes of companies from a database about various industries maintained by various social networking system users.

Retrieved information about job titles associated with companies that are associated with an industry may be refined by mapping each job title to an ontology of job titles maintained by the social networking system to reduce redundancy. In various embodiments, the social networking system may maintain different ontologies associated with different industries. For example, a job title of “stewardess” provided in a user profile is mapped to a job title of “flight attendant” in the ontology. The mapping may be based on a set of rules or based on measures of between a job title specified in a user profile and job titles included in the ontology measured by methods including string matching, Naïve Bayes classification, edit distance, or any other suitable method. The job title specified in the user profile may be mapped to a job title in the ontology having a maximum measure of similarity to the job title specified in the user profile. In one embodiment, a measure of similarity between a job title in a user profile and a job title in the ontology is based on an amount of modification to the job title in the user profile to match a job title in the ontology. For example, if a job title specified by a user profile does not match any job title in the ontology, but matches a job title in the ontology after less than a threshold number of insertions, deletions, and/or substitutions are performed on the characters of the job title specified by the user profile, the job title specified by the ontology is mapped to the job title in the ontology.

The model to infer an industry associated with a company is trained based on job titles associated with employees of each company associated with an industry. For example, for multiple companies, job titles associated with various employees of a company are aggregated to determine a value associated with the company based on a number of employees of the company having different job titles. For example, values are associated with different job titles associated with a company and a centroid of the values is determined based on a distribution of employees of the company having various job titles is determined as a value associated with the company. Based on the values associated with various companies associated with an industry, a centroid of the values associated with the various companies is determined as an industry value associated with the industry. Based on industry values associated with various industries, a machine-learned model is trained to infer an industry associated with a company. The model determines an industry value associated with a company based on a value associated with the company determined from a distribution of job titles associated with the company, with an industry corresponding to the determined industry value associated with the company. In one embodiment, the values computed for each company are normalized so the values of companies in an industry are uniform, regardless of the size of a company For example, if the values computed for each company are represented as vectors, the value of each vector is normalized to a length of 1.

In one embodiment, a company that is not associated with an industry is identified, and a value is determined based on the distribution of job titles among employees the identified company. The trained model is applied to the value for the identified company to infer an industry associated with the identified company. For example, a cosine similarity is computed between a centroid vector of job titles of employees of a company and a centroid vector for various industries is determined based on centroids of job titles of employees of additional companies in each industry. A measure of similarity between the centroid vector of job titles of employees and the company and the centroids of job titles associated with various industries, such as a cosine similarity, is determined, and an industry corresponding to the highest cosine similarity is associated with the company.

A user's job title may also be inferred based on the industry of a company identified by the user as an employer. For example, if user profile specifies a company as an employer but does not specify a job title, an industry of the company is inferred by the model. Based on the inferred industry, a job title is inferred for the user based on a distribution of job titles associated with the industry. For example, a centroid value is determined from the distribution of job titles in the industry, and a job title associated with the centroid value is associated with the user. A user's job title may also be inferred based on additional information such as other companies identified by the user listed as previous employers and previous job titles the user listed in their user profile. The job titles of users inferred from the ontology of job titles maintained by the social networking system may be used to target users with different job titles (e.g., job titles corresponding to various positions in a hierarchy of a company) with content such as advertisements, suggestions to join a group, suggestions to attend an event, or other suitable content.

Additionally, the social networking system may infer whether a user is a small business owner by applying one or more rules to information included in the user's user profile (e.g., an employer or job title). For example, the social networking system infers that a user is a small business owner if the user declares that they are “self-employed” when prompted to provide information describing an employer. The social networking system may use this information to identify content for presentation to the user that is relevant to small business owners (e.g., advertisements, events, groups, actions, etc.).

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flow chart of a method for inferring an industry associated with a company associated with a social networking system user, in accordance with an embodiment.

FIG. 4A is an example of inferring a relationship status associated with a social networking system user, in accordance with an embodiment.

FIG. 4B is an example determination of an industry value, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

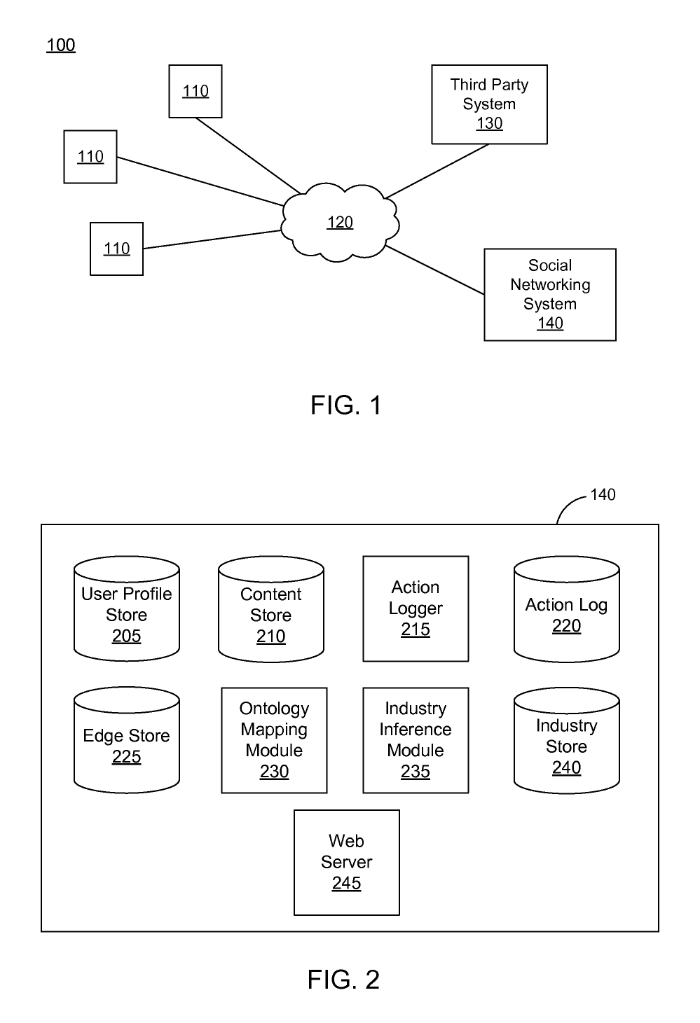

FIG. 1 is a block diagram of a system environment 100 for a social networking system 140. The system environment 100 shown by FIG. 1 comprises one or more client devices 110, a network 120, one or more third party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

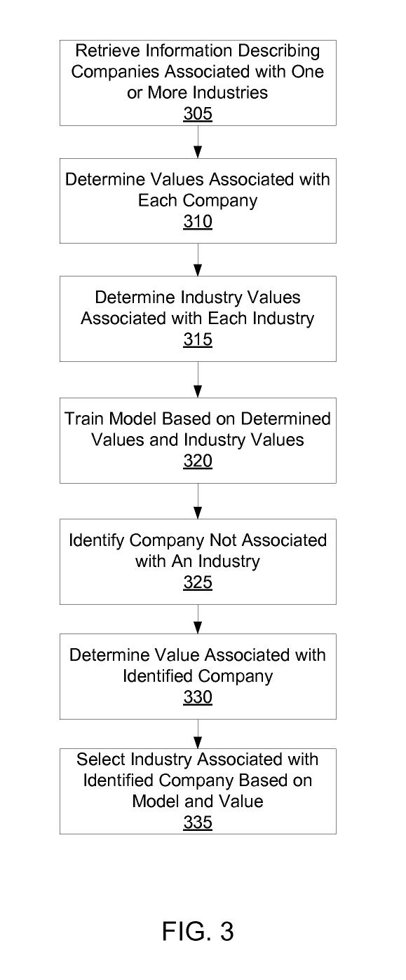

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, an ontology mapping module 230, an industry inference module 235, an industry store 240, and a web server 245. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

The user profile store 205 may include employment information associated with one or more users. For example, a user identifies a current employer and a job title in a user profile to describe the user's current employment status. Additionally, a user profile may identify one or more previous employers and previous job titles, allowing the user profile to describe at least a portion of a user's employment history. However, users may provide varying amounts of information describing their employment. For example, a user may identify a name of a current employer while not identifying a job title. As another example, a user may provide no information describing current or previous employment.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140. In one embodiment, the content store 210 includes one or more user identifiers that identify one or more social networking system users presented with a content item that are stored in association with the stored content item.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The ontology mapping module 230 maintains an ontology specifying hierarchical information associated with job titles for classifying and refining job titles provided by users. Different ontologies may be maintained for different industries. For example, an ontology related to engineering jobs includes engineering as a broadest job category and increasingly specific categories for various engineering disciplines such as civil engineering and structural engineering. Maintaining one or more ontologies associated with job titles allows the ontology mapping module to refine job titles declared by social networking system users to reduce redundancy by mapping user-specified job titles to job titles in the ontology.

In one embodiment, the ontology mapping module 230 matches a job title specified by a user to a job title included in an ontology by applying one or more rules to the job title specified by the user. For example, “ear nose and throat doctor,” “ear nose and throat physician,” “ENT doctor,” “ENT physician,” and “otolaryngologist” are all mapped to the job title “otolaryngologist” in the ontology based on rules mapping user-declared job titles to synonymous job titles in the ontology. Alternatively, measures of similarity between a job title specified by a user and various job titles in an ontology based on string matching, Naïve Bayes classification, edit distance or any other suitable method. The user-specified job title is mapped to a job title in the ontology having a maximum measure of similarity. For example, if a user-specified declared job title does not match any job title in the ontology, but matches a job title in the ontology after less than a threshold number of insertions, deletions, and/or substitutions are performed on the characters of the job title specified by the user profile, the job title specified by the ontology is mapped to the job title in the ontology. As an additional example, if a declared job title does not exactly match any job title in the ontology, the declared job title is mapped to a job title in the ontology based on portions of the declared job title matching broad job titles in the ontology. For example, a job title of “eye doctor” specified by a user is mapped to the job of “doctor” as a determination whether the user is an optometrist or an ophthalmologist cannot be made from the specified job title. In an additional example, a job title of “veterinarian” specified in a profile of a social networking system user is mapped to the job title of “veterinary physician” in the ontology based on measures of similarity between the specified job title and job titles in the ontology determined by applying a naïve Bayes classification algorithm to the specified job title and job titles in the ontology.

The industry inference module 235 determines a model for inferring an industry associated with a company based on distributions of job titles of employees of companies associated with industries. In one embodiment, values are associated with vectors representing various job titles, and a centroid vector based on the job title values is determined for a company based on the job titles associated with employees of the company. For example, a centroid vector is calculated for a company based on multiple dimensions each corresponding to a job title, with a vector in a dimension representing a number of employees associated with the company having a job title corresponding to the dimension. In one embodiment, the centroid vector for a company is normalized so the lengths of vectors associated with job titles from companies in an industry are uniform (e.g., equal to 1), regardless of the size of a company. Different values may be computed for companies and subsidiaries of a company associated with various industries. Alternatively, no values may be computed for conglomerates of a company associated with multiple industries.

Based on values associated with multiple companies associated with an industry, the industry inference module 235 determines an industry value associated with the industry. The industry inference module 235 determines industry values associated with multiple industries based on values associated with companies associated with each industry. For example, an industry value for an industry is a centroid vector calculated based on the job title vectors calculated for each company of the industry. In alternate embodiments, an industry value for an industry is a centroid vector calculated based on the centroid vectors calculated for each company of the industry from the job titles associated with each company. Based on the industry values and the values associated with various companies, the industry inference module 235 trains a model for various industries to identify an industry based on one or more values associated with a company.

The industry inference module 235 applies the trained model to a value determined for a company based on a distribution of job titles associated with the company and determines an industry value based on the value. An industry corresponding to the determined industry value is then associated with the company. In some embodiments, different models are determined for companies having different sizes (e.g., small businesses, mid-size businesses, large businesses, etc.) to more accurately identify an industry. Hence, the model allows the industry inference module 235 to infer an industry associated with a company that has not specified an industry.

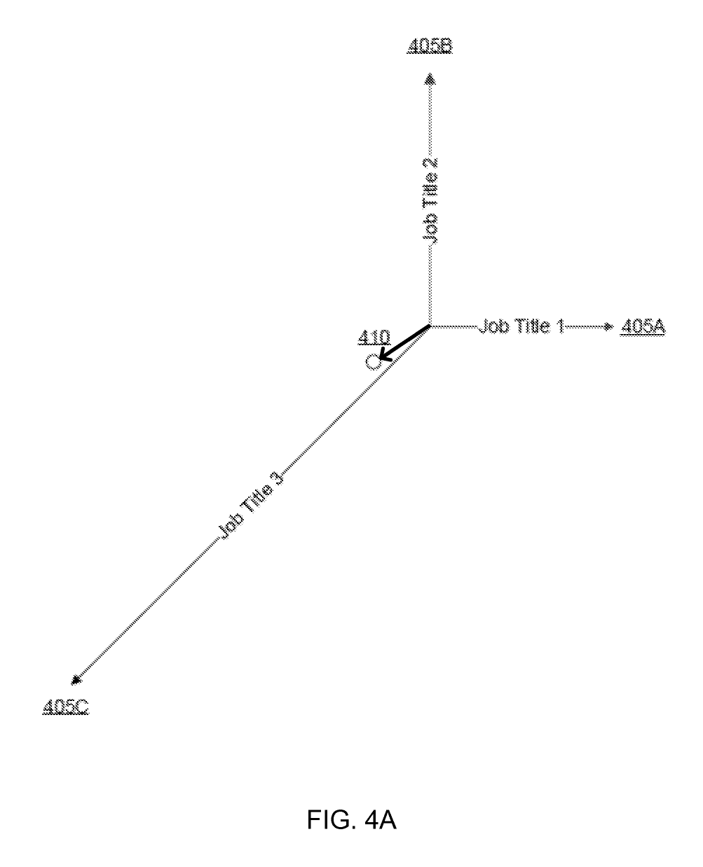

After identifying a company that is not associated with an industry, the industry inference module 235 computes a value associated with the identified company based on a distribution of job titles associated with users of the social networking system 140 specifying the identified company as an employer. The distribution of job titles among employees of the company may be determined based on information in the user profile store 205, in the action log 220, in the edge store 230, from a database about the company, or from any suitable source. The model is applied to the value for the identified company to determine an industry value based on the value for the identified company. For example, the model determines a cosine similarity between vectors of job titles associated with different companies associated with an industry. In other embodiments, the model determines a cosine similarity between a centroid vector of job titles for the identified company and a centroid vector of job titles for each industry. An industry corresponding to the maximum cosine similarity is inferred as the industry of the identified company. In some embodiments, the industry inference module 235 trains the model using defined clusters of centroid vectors associated with companies in each industry, using a k-nearest neighbors algorithm, or any other suitable algorithm. Inferring an industry associated with a company is further described below in conjunction with FIG. 3.

Additionally, in some embodiments, the industry inference module 235 infers a job title associated with a user of the social networking system 140 based on an industry of a company specified as an employer by the user. For example, if user's user profile specifies a company as an employer but does not specify a job title, the job title of the user is inferred by using the model to infer an industry of the company. Based on the industry of the company, a job title is selected from a distribution of job titles associated with the industry. For example, a most common job title associated with the industry is identified and associated with the user. If the company specified by the user is associated with an industry, a job title associated with the user is determined based on the distribution of job titles associated with the industry. A user's job title may also be inferred based on additional information specified by the user, such as other companies the specified by the user as previous employers, previous job titles specified by the user in its user profile, etc.

The industry store 240 stores information associated with various industries and companies associated with different industries. For example, the industry store 240 stores information associated with various companies retrieved from databases maintained by or associated with each company. The industry store 240 groups the retrieved information based on industries associated with various companies. Examples of the retrieved information include a number of employees of various job titles in each company, types of products and/or services offered by each company, sizes of each company, or other suitable information. In some embodiments, information is retrieved from user profiles associated with companies and maintained by the social networking system 140. Information in the industry store 240 associates companies with industries, including associations between a company and an industry inferred by the industry inference module 235. An industry inferred for a company may also be stored in user profiles of users identifying the company as an employer.

The web server 245 links the social networking system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the social networking system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

Inferring an Industry Associated with a Company

FIG. 3 is flow chart of one embodiment of a method for inferring a company associated with a user of the social networking system 140. In other embodiments, the method includes different, additional, or fewer steps than those depicted by FIG. 3.

The social networking system 140 retrieves 305 information associated with companies that are associated with an industry. For example, the social networking system 140 retrieves 305 information from a database including a geographic location of a headquarters of each company, a number of employees of various job titles in each company, types of products and/or services offered by each company, etc. Information may be retrieved 305 from user profiles associated with companies and maintained by the social networking system or from one or more databases external to the social networking system such as FREEBASE™ or any other suitable database of information. In some embodiments, retrieved information may be stored in the industry store 240.

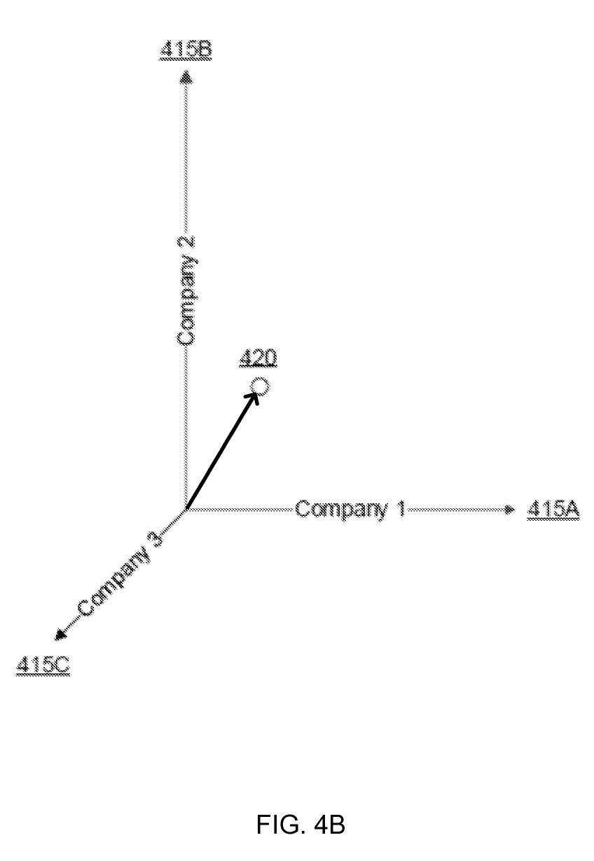

Based on the retrieved information, the social networking system 140 determines 310 values associated with each company. To determine 310 a value associated with a company, the social networking system 140 identifies job titles associated with employees of the company and determines a distribution of job titles representing a number of employees of the company having different job titles. Each job title corresponds to a value, and the value associated with a company is determined 310 based on the values corresponding to various job titles and a number of employees having each job title. In one embodiment, the value associated with the company is a vector of values corresponding to job titles determined from the distribution of job titles associated with the company. In an alternate embodiment, the value associated with the company is a centroid of the values corresponding to job titles determined from the distribution of job titles associated with the company. For example, a centroid vector is determined 310 for a company based on multiple dimensions each corresponding to a job title, with a vector in a dimension representing a number of employees associated with the company having a job title corresponding to the dimension. In one embodiment, a centroid vector determined 310 for each company is normalized so lengths of vectors from multiple companies are uniform (e.g., equal to 1), regardless of the number of employees of a company. The normalization may be based on an industry associated with various companies. Hence, the value associated with the company represents an average job titles associated with an employee of the company. An example determination of a value for a company is further described below in conjunction with FIG. 4A.

The social networking system 140 determines 315 an industry value associated with various industries, with an industry value associated with an industry determined 315 based on the values associated with companies associated with the industry. For example, an industry value is determined as a centroid vector of the centroid vectors of job titles determined for each company associated with an industry. An example determination of an industry value is further described below in conjunction with FIG. 4B.

Using the industry values associated with various industries and the values associated with various companies associated with one or more industries, the social networking system 140 trains 320 a model to infer an industry from one or more values associated with a company. For example, a machine-learned model is trained 320 to identify an industry value based on a value associated with a company, and to associate an industry corresponding to the identified industry value with the company. The model may determine a measure of similarity between a value associated with a company and multiple industry values and select an industry value associated with the maximum measure of similarity. An industry corresponding to the selected industry value is then associated with a company. In some embodiments, different models are trained 320 for application to companies having different sizes (e.g., companies that are less than or greater than a threshold size),

After training 320 one or more models, the social networking system 140 identifies 325 a company that is not associated with an industry. In one embodiment, the social networking system 140 retrieves employment information from a user profile and determines whether a company specified by the user profile as an employer is associated with an industry. For example, users declare information in their user profiles specifying employment information such as job titles, employers, their professional skills, etc. If a user's declared information includes a company name, the social networking system determines whether the social networking system 140 maintains information associating the company with an industry. In some embodiments, the social networking system 140 identifies 325 a company not associated with an industry in response to a received request, while in other embodiments, the social networking system 140 automatically identifies 325 one or more companies that are not associated with an industry.

As described above, the social networking system 140 determines 330 a value associated with the identified company based on a distribution of job titles associated with employees of the identified company. The trained model is applied to the value associated with the identified company to select 330 one or more industries associated with the identified company. In some embodiments, the social networking system 140 determines the value using a cosine similarity between a vector of job title s associated with the identified company and vectors of job titles associated with various industries. In alternate embodiments, the value associated with the identified company is a centroid vector of job titles associated with the identified company, and the model determines a cosine similarity (or other measure of similarity) between the centroid vector for the identified company and centroid vectors of job titles associated with various industries. An industry associated with a centroid vector of job titles associated with the industry having a maximum cosine similarity or other measure of similarity to the centroid vector for the identified company is selected 330 for association with the identified company. The social networking system 140 stores information associating the selected one or more industries with the identified company, allowing the social networking system 140 to subsequently use the selected one or more industries when selecting content for presentation to users that specify the company as an employer.

In some embodiments, the industry associated with a company is also used to infer a job title associated with a social networking system user that has identified the company as an employer but that has not specified a job tile. For example, a job title of a user is inferred as a job title corresponding to a centroid vector (or other average value) of job titles associated with an industry associated with a company identified by the user as an employer. A user's job title may also be inferred based on additional information specified by the user in a user profile, such as other companies identified as previous employers, previous job titles specified by the user listed in their user profile.

Example Determination of Value Associated with a Company and Industry Value

FIG. 4A shows an example determination of a value associated with a company. In the example of FIG. 4A, three job titles are associated with employees of the company, with each job title associated with a different dimension. Vectors 405A, 405B, 405C are associated with each dimension, so each vector 405A, 405B, 405C has a length or other value based on a number of employees of the company associated with a job title corresponding to a dimension. The value 410 associated with the company is determined as a centroid vector representing an intersection of medians of the vectors 405A, 405B, 405C associated with each dimension. Hence, the centroid vector is an intersection of the medians of the vertices of a polygon formed by the vectors 405A, 405B, 405C, which each represent a number of employees associated with each job title in the company. A value for a company associated with a larger number of job titles may be similarly determined using additional dimensions. In alternate embodiments, the value 410 associated with the company is determined by calculating a normalized average of the job title vectors.

FIG. 4B shows an example of determining an industry value based on values associated with companies associated with an industry. In the example of FIG. 4B, the values associated with companies are centroid vectors, such as those determined in the example of FIG. 4A. Each company associated with the industry is associated with a direction, and a vector 415A, 415B, 415C having a length or other value is associated with each direction based on the value associated with a company associated with the direction. A centroid of the vectors is determined, as described above in conjunction with FIG. 4A, to determine the industry value 420 associated with the industry.

Inferring Social Networking System Users that are Small Business Owners

The social networking system 140 may also infer whether a user of the social networking system 140 is a small business owner by applying one or more rules to information included in the user's user profile. Examples of information in a user profile to which the one or more rules are applied include an employer, a job title, or other suitable information. For example, if a user of the social networking system specifies an employer of “self-employed,” the social networking system 140 infers that the user is a small business owner. As an additional example, if a social networking system user specifies a job title of “self-employed” or “owner” in a user profile, the social networking system 140 infers that the user is a small business owner if the user profile also identifies an employer having less than a threshold number of employees (e.g., based on information retrieved from the industry store 240).

Whether a user is identified as a small business owner may be used by the social networking system 140 to select content for presentation to the user, such as advertisements or recommendations for actions (e.g., joining a group, attending an event) relevant to small business owners. For example, advertisements associated with a targeting criteria specifying a small business owner are identified as eligible for presentation to users inferred to be small business owners. As an additional example, the social networking system 140 recommends certain actions to users identified as small business owners (e.g., creating a page maintained by the social networking system 140 to promote the businesses, joining a group including other users identified as small business owners, etc.)

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
retrieving, by a social networking system, information describing one or more companies each associated with one or more industries, the information associated with a company including a distribution of job titles of employees of the company;
determining values for the one or more companies based at least in part on the retrieved information, a value associated with the company based at least in part on the distribution of job titles of employees of the company;
determining industry values associated with each of the one or more industries, an industry value associated with an industry based at least in part on one or more determined values associated with one or more companies associated with the industry;
identifying a company not associated with one or more industries from a user profile and identified by a user profile of a user of a social networking system;
determining a value for the identified company based at least in part on information describing a distribution of job titles of employees of the identified company; and
selecting an industry for association with the identified company based at least in part on the value for the identified company and the industry values.

2. The method of claim 1, wherein determining values for the one or more companies comprises:
retrieving information describing a hierarchical relationship of a plurality of job titles maintained by the social networking system;
matching job titles of employees of the company with job titles included in the hierarchical relationship of the plurality of job titles; and
determining the value for the company based at least in part on a distribution of job titles included in the hierarchical relationship of the plurality of job titles matching job titles of employees of the company.

3. The method of claim 2, wherein matching job titles of employees of the company with job titles included in the hierarchical relationship of the plurality of job titles comprises:
selecting a job title of an employee of the company;
determining measures of similarity between the job title of the employee of the company and at least a set of job titles included in the hierarchical relationship of the plurality of job titles; and
matching the job title of the employee of the company with a job title included in the set of job titles included in the hierarchical relationship of job titles based at least in part on the measures of similarity.

4. The method of claim 3, wherein matching the job title with the job title included in the hierarchical relationship of job titles based at least in part on the measures of similarity comprises:
matching the job title of the employee of the company with a job title included in the set of job titles included in the hierarchical relationship of job titles associated with a maximum measure of similarity.

5. The method of claim 1, wherein determining values for the one or more companies comprises:
associating a plurality of dimensions with the company, each of the plurality of dimensions associated with a job title;
determining a value for each of the plurality of dimensions, a value for a dimension based at least in part on a number of employees of the company having the job title associated with the dimension; and
determining the value associated with the company based at least in part on the values for each of the plurality of dimensions.

6. The method of claim 5, wherein determining the value associated with the company based at least in part on the values for each of the plurality of dimensions comprises:
determining a centroid of the values for each of the plurality of dimensions.

7. The method of claim 1, further comprising:
identifying a job title associated with the user of the social networking system based at least in part on the selected industry.

8. The method of claim 7, wherein identifying the job title associated with the user of the social networking system based at least in part on the selected industry comprises:
identifying a distribution of job titles associated with employees of companies associated with the selected industry; and
selecting the job title associated with the user based at least in part on the distribution of job titles associated with employees of companies associated with the selected industry.

9. The method of claim 7, wherein the job title associated with the user of the social networking system is also identified based at least in part on one or more selected from a group consisting of: one or more additional companies specified by the user profile of the user, one or more additional job titles specified by the user profile of the user, and any combination thereof.

10. The method of claim 1, wherein selecting the industry for association with the identified company based at least in part on the value for the identified company and the industry values comprises:
applying a model to the value for the identified company to determine an industry value associated with the identified company, the model determining the industry value associated with the identified company based at least in part on the determined values for the one or more companies and the determined values associated with the one or more companies; and
selecting an industry associated with the industry value associated with the identified company.

11. A method comprising:
retrieving, by a social networking system, information describing one or more companies each associated with one or more industries, the information associated with a company including a distribution of job titles of employees of the company;
determining industry values for each of the one or more industries based at least in part on the retrieved information, an industry value associated with an industry based at least in part on distributions of job titles of employees of one or more companies associated with the industry;
identifying a company not associated with one or more industries from a user profile and identified by a user profile of a user of a social networking system;
determining a value associated with the identified company based at least in part on a distribution of job titles of one or more employees of the identified company;
determining an industry value associated with the identified company based at least in part on the value associated with the identified company and the determined industry values; and
associating an industry associated with the determined industry value associated with the identified company for association with the identified company.

12. The method of claim 11, wherein determining industry values for each of the one or more industries based at least in part on the retrieved information comprises:
determining values for the one or more companies associated with the industry based at least in part on the distribution of job titles of employees of the company; and
determining the industry value associated with the industry based at least in part on the determined values for the one or more companies associated with the industry.

13. The method of claim 11, wherein determining industry values for each of the one or more industries based at least in part on the retrieved information comprises:
retrieving information describing a hierarchical relationship of a plurality of job titles maintained by the social networking system;
matching job titles of employees of companies associated with the industry with job titles included in the hierarchical relationship of the plurality of job titles; and
determining the industry value for the industry based at least in part on distributions of job titles included in the hierarchical relationship of the plurality of job tittles matching job titles of employees of companies associated with the industry.

14. The method of claim 13, wherein matching job titles of employees of companies associated with the industry with job titles included in the hierarchical relationship of the plurality of job titles:
selecting a job title of an employee of a company associated with the industry;
determining measures of similarity between the job title of the employee of the company and at least a set of job titles included in the hierarchical relationship of the plurality of job titles; and
matching the job title of the employee of the company associated with the industry to a job title included in the set of job titles included in the hierarchical relationship of job titles based at least in part on the measures of similarity.

15. The method of claim 14, wherein matching the job title of the employee of the company associated with the industry to the job title included in the hierarchical relationship of job titles based at least in part on the measures of similarity comprises:
matching the job title of the employee of the company associated with the industry with a job title included in the set of job titles included in the hierarchical relationship of job titles associated with a maximum measure of similarity.

16. The method of claim 11, further comprising:
identifying a job title associated with the user of the social networking system based at least in part on the selected industry.

17. The method of claim 16, wherein identifying the job title associated with the user of the social networking system based at least in part on the selected industry comprises:
identifying a distribution of job titles associated with employees of companies associated with the selected industry; and
selecting the job title associated with the user based at least in part on the distribution of job titles associated with employees of companies associated with the selected industry.

18. The method of claim 16, wherein the job title associated with the user of the social networking system is also identified based at least in part on one or more selected from a group consisting of: one or more additional companies specified by the user profile of the user, one or more additional job titles specified by the user profile of the user, and any combination thereof.

19. The method of claim 11, wherein determining the industry value associated with the identified company based at least in part on the value associated with the identified company and the determined industry values further comprises:
determining measures of similarity between the value associated with the identified company and a plurality of industry values; and
selecting an industry value having a maximum measure of similarity with the value associated with the identified company.

20. A computer program product comprising a computer-readable storage medium having instructions encoded thereon that, when executed by a processor, cause the processor to:
retrieve, by a social networking system, information describing one or more companies each associated with one or more industries, the information associated with a company including a distribution of job titles of employees of the company;
determine values for the one or more companies based at least in part on the retrieved information, a value associated with the company based at least in part on the distribution of job titles of employees of the company;
determine industry values associated with each of the one or more industries, an industry value associated with an industry based at least in part on one or more determined values associated with one or more companies associated with the industry;
identify a company not associated with one or more industries from a user profile and identified by a user profile of a user of a social networking system;
determine a value for the identified company based at least in part on information describing a distribution of job titles of employees of the identified company; and
select an industry for association with the identified company based at least in part on the value for the identified company and the industry values.
